(19) United States
(12) Patent Application Publication
(10) Pub. No.: US 2026/0259636 A1
(43) Pub. Date: Sep. 3, 2026

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventor: Tadamasa TOMA, Osaka (JP)

(73) Assignee: PANASONIC INTELLECTUAL PROPERTY MANAGEMENT CO., LTD., Osaka (JP)

(21) Appl. No.: 19/659,674

(22) Filed: Apr. 27, 2026

Related U.S. Application Data
(63) Continuation of application No. PCT/JP2024/038492, filed on Oct. 29, 2024.
(60) Provisional application No. 63/547,000, filed on Nov. 2, 2023.

(30) Foreign Application Priority Data
May 22, 2024 (JP) 2024-083359

(51) Int. Cl. G06F 3/04815; G06F 3/04817; G06T 7/11

(52) U.S. Cl. CPC G06F 3/04815; G06F 3/04817; G06T 7/11

(57) ABSTRACT

An information processing method includes: displaying a bird’s-eye view for a workspace on a display of an information terminal; and displaying, in the bird’s-eye view, a plurality of photographing spot icons respectively indicating a plurality of photographing spots. The photographing spots include a first photographing spot and a second photographing spot related to photographing executed at a later time than photographing at the first photographing spot. The displaying of the photographing spot icons includes changing an interval between a first photographing spot icon indicating the first photographing spot and a second photographing spot icon indicating the second photographing spot in accordance with a workflow in the workspace.

### FIELD OF INVENTION

The present disclosure relates to a technology of displaying an image.

### BACKGROUND ART

For instance, Patent Literature 1 discloses a technology of setting a photography recommended position so as to fall within a range of a preset distance from a reference point, that is, to fall within a range of a distance where a three-dimensional image continuous with an omnidirectional image captured at the reference point can be generated. Moreover, for example, Patent Literature 1 further discloses that the technology includes: setting, depending on a layout representing how rooms, facilities, or etc. are arranged on a photography target floor, a photography necessary area or a photography unnecessary area on the photography target floor; and excluding the photography unnecessary area on the photography target floor when the photography recommended position is set.

Unfortunately, the conventional technology decides the photography recommended position so as to fall within the range of the preset distance from the reference point, and the photography necessary area or the photography unnecessary area is predetermined depending on the layout representing how rooms, facilities, or etc. are arranged on the photography target floor. The conventional technology hence fails to disclose changing an interval between a plurality of photographing spot icons respectively indicating a plurality of photographing spots in accordance with a workflow, and thus needs further improvement.

Patent Literature 1: Japanese Unexamined Patent Publication No. 2022-12447

### SUMMARY OF THE INVENTION

This disclosure has been accomplished to overcome the disadvantages described above, and has an object of providing a technology to enable change in an interval between a plurality of photographing spot icons respectively indicating a plurality of photographing spots in accordance with a workflow.

An information processing method according to an aspect of the present disclosure is an information processing method to be executed by a computer, and includes: displaying a bird’s-eye view for a workspace on a display of an information terminal; and displaying, in the bird’s-eye view, a plurality of photographing spot icons respectively indicating a plurality of photographing spots. The photographing spots include a first photographing spot and a second photographing spot related to photographing executed at a later time than photographing at the first photographing spot. The displaying of the photographing spot icons includes changing an interval between a first photographing spot icon indicating the first photographing spot and a second photographing spot icon indicating the second photographing spot in accordance with a workflow in the workspace.

This disclosure enables change in an interval between a plurality of photographing spot icons respectively indicating a plurality of photographing spots in accordance with a workflow.

### BRIEF DESCRIPTION OF THE DRAWINGS

FIG. 1 is diagram showing an overall configuration of an information processing system in an embodiment.

FIG. 2 illustrates an example design drawing screen image in which a plurality of photographing spot icons at intervals to be changed is superimposed.

FIG. 3 illustrates an example design drawing screen image, in which a first photographing spot icon and a second photographing spot icon at an interval having been changed are superimposed, for a first work stage.

FIG. 4 illustrates an example design drawing screen image, in which a first photographing spot icon and a second photographing spot icon at an interval having been changed are superimposed, for a second work stage coming after the first work stage.

FIG. 5 is a flowchart showing an example of a process by a server in the embodiment.

FIG. 6 is a schematic diagram to explain decision of a reference distance by a display control part in a second modification of the embodiment.

FIG. 7 is a schematic diagram to explain decision of a reference distance by a display control part in a third modification of the embodiment.

FIG. 8 is a s schematic diagram to explain change in a photographing spot icon by a display control part in a fifth modification of the embodiment.

### DETAILED DESCRIPTION

Knowledge forming the basis of the present disclosure

A user interface has been developed to display, in a two-dimensional design drawing for a worksite or other site, a plurality of photographing spot icons respectively indicating photographing spots where the worksite is actually photographed, and to display an image captured at a certain photographing spot indicated by corresponding one photographing spot icon in response to selection of the one photographing spot icon. This configuration allows a manager of the worksite to grasp a situation of the worksite without visiting the worksite.

The conventional technology decides a photographing spot for photographing by a photographing person so as to fall within a range of a preset distance from a reference point. The conventional technology further predetermines a photography necessary area or a photography unnecessary area on a photography target floor depending on a layout representing how rooms, facilities, or etc. are arranged on the photography target floor.

The conventional technology accordingly faces difficulty in increasing or reducing the number of photographing spots in accordance with a workflow.

The following technologies will be disclosed to overcome the disadvantages.

(1) An information processing method according to an aspect of the disclosure is an information processing method to be executed by a computer, and includes: displaying a bird’s-eye view for a workspace on a display of an information terminal; and displaying, in the bird’s-eye view, a plurality of photographing spot icons respectively indicating a plurality of photographing spots. The photographing spots include a first photographing spot and a second photographing spot related to photographing executed at a later time than photographing at the first photographing spot. The displaying of the photographing spot icons includes changing an interval between a first photographing spot icon indicating the first photographing spot and a second photographing spot icon indicating the second photographing spot in accordance with a workflow in the workspace.

This configuration includes changing the interval between the first photographing spot icon indicating the first photographing spot and the second photographing spot icon indicating the second photographing spot in accordance with a workflow, and thus enables change in an interval between a plurality of photographing spot icons respectively indicating a plurality of photographing spots in accordance with the workflow. The configuration that includes changing the interval between the photographing spot icons in accordance with the workflow avoids an increase in the number of processing steps by a computer, and hence prevents an increase in a burden on computer resources.

(2) In the information processing method according to (1) above, the displaying of the photographing spot icons may include making the interval between the first photographing spot icon and the second photographing spot icon shorter as the workflow proceeds.

For instance, at an initial stage of a workflow for a construction work, structures including a wall are not yet made in a workspace. That is to say, there are fewer structures which obstruct a visual field of a worker, and hence, it is not required to set a plurality of photographing spots densely. In contrast, at a later stage of the workflow for the construction work, such structures including the wall are gradually completed in the workspace and the number of structures which obstruct the visual field of the worker increases, and hence, it is required to set a plurality of photographing spots densely. This configuration includes making the interval between the first photographing spot icon and the second photographing spot icon shorter as the workflow proceeds, and thus enables setting of a plurality of photographing spot icons apart from each other at an initial stage of a workflow and setting of a plurality of photographing spot icons densely at a later stage of the workflow.

(3) The information processing method according to (1) or (2) may further include specifying a work stage in the workflow on the basis of an interval between structures in the workspace.

To cope with an increase in the number of structures in the workspace in the progress of the workflow, the configuration enables specifying of a work stage by detecting an interval between the structures in the workspace.

(4) The information processing method according to any one of (1) to (3) may include deciding, on the basis of the workflow, a reference distance for an interval between two photographing spots being continuous in time-series among the photographing spots. The displaying of the photographing spot icons may further include: selecting the first photographing spot from among the photographing spots, and selecting, as the second photographing spot, a photographing spot located at the reference distance or farther away from the selected first photographing spot; and displaying, in the bird’s-eye view, the first photographing spot icon indicating the selected first photographing spot and the second photographing spot icon indicating the selected second photographing spot.

This configuration includes deciding, on the basis of the workflow, a reference distance for an interval between two photographing spots being continuous in time-series among the photographing spots, selecting the first photographing spot, and selecting, as the second photographing spot, a photographing spot located at the reference distance or farther away from the selected first photographing spot. The configuration consequently enables easier setting of the interval between the first photographing spot and the second photographing spot from the reference distance in association with a work stage.

(5) In the information processing method according to (4) above, the reference distance may be shorter as the interval between structures in the workspace is shorter.

This configuration enables setting of a plurality of photographing spots more densely as the interval between structures in the workspace is shorter.

(6) The information processing method according to (4) or (5) may further include dividing the bird’s-eye view into a plurality of regions. The deciding of the reference distance may include deciding the reference distance on the basis of an area of each of the regions, a length of a perimeter of each of the regions, a horizontal dimension of each of the regions, or a vertical dimension of each of the regions.

This configuration enables decision of the reference distance in association with a current work stage, on the basis of an area of each of a plurality of regions, a length of a perimeter of each of the regions, a horizontal dimension of each of the regions, or a vertical dimension of each of the regions.

(7) In the information processing method according to (6), the dividing of the bird’s-eye view may include dividing the bird’s-eye view into the regions in such a manner as to be each surrounded by a wall.

This configuration includes dividing the bird’s-eye view into the regions in such a manner as to be each surrounded by a wall, and thus enables change in the interval between the photographing spots through making each region, i.e., each room or chamber, surrounded by the wall.

(8) In the information processing method according to (6), the dividing of the bird’s-eye view may include dividing the bird’s-eye view into the regions in a grid shape, and the deciding of the reference distance may include deciding the reference distance on the basis of the horizontal dimension or the vertical dimension that is defined between associated walls included in the region.

This configuration enables change in the interval between the photographing spots through making walls in each region resulting from the dividing in the grid shape.

(9) In the information processing method according to (4) or (5), the deciding of the reference distance may include: dividing the bird’s-eye view into a plurality of regions; and deciding the reference distance for each of the regions.

This configuration includes dividing the bird’s-eye view into a plurality of regions and deciding the reference distance for each of the regions, and thus enables change in the interval between the photographing spot icons for each of the regions.

(10) The information processing method according to any one of (1) to (9) above may further include deciding, when a distance between the second photographing spot and a certain structure in the workspace has a value lower than a threshold, a photographing spot located at a distance of the threshold or higher away from the structure among the photographing spots as the second photographing spot.

In a case where the second photographing spot is closer to a certain structure, an image captured at the second photographing spot means an image captured at an extremely short distance from the structure. This makes it difficult for a worker to confirm a state of the structure from the image. In this regard, the configuration includes deciding, when the distance between the second photographing spot and the certain structure in the workspace has a value lower than the threshold, a photographing spot located at a distance of the threshold or higher away from the structure among the photographing spots as the second photographing spot. The worker hence can confirm the state of the structure from an image captured at the second photographing spot located at the distance of the threshold or higher away from the structure.

Moreover, the disclosure can be realized as: the information processing method executing the above-described distinctive ways; and a information processing device including each distinctive feature corresponding to the distinctive ways executed by the information processing method. Additionally, the disclosure can be realized by a computer program causing a computer to execute the distinctive ways included in the information processing method. From these perspectives, the same advantageous effects as those of the information processing method are achievable in the following other aspects.

(11) An information processing device according to another aspect of the present disclosure includes a processor. The processor is configured to: display a bird’s-eye view for a workspace on a display of an information terminal; and display, in the bird’s-eye view, a plurality of photographing spot icons respectively indicating a plurality of photographing spots. The photographing spots include a first photographing spot and a second photographing spot related to photographing executed at a later time than photographing at the first photographing spot. In the displaying of the photographing spot icons, an interval between a first photographing spot icon indicating the first photographing spot and a second photographing spot icon indicating the second photographing spot is changed in accordance with a workflow in the workspace.

(12) An information processing program according to still another aspect of the present disclosure includes causing a computer to: display a bird’s-eye view for a workspace on a display of an information terminal; and display, in the bird’s-eye view, a plurality of photographing spot icons respectively indicating a plurality of photographing spots. The photographing spots include a first photographing spot and a second photographing spot related to photographing executed at a later time than photographing at the first photographing spot. In the displaying of the photographing spot icons, an interval between a first photographing spot icon indicating the first photographing spot and a second photographing spot icon indicating the second photographing spot is changed in accordance with a workflow in the workspace.

(13) A non-transitory computer readable recording medium according to another aspect of the present disclosure stores an information processing program described in (12) above.

An embodiment of this disclosure will be described with reference to the accompanying drawings. The embodiment which will be described below represents a specific example of the disclosure. Numeric values, shapes, constituent elements, steps, and the order of the steps described below in the embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in all the embodiments.

### Embodiment

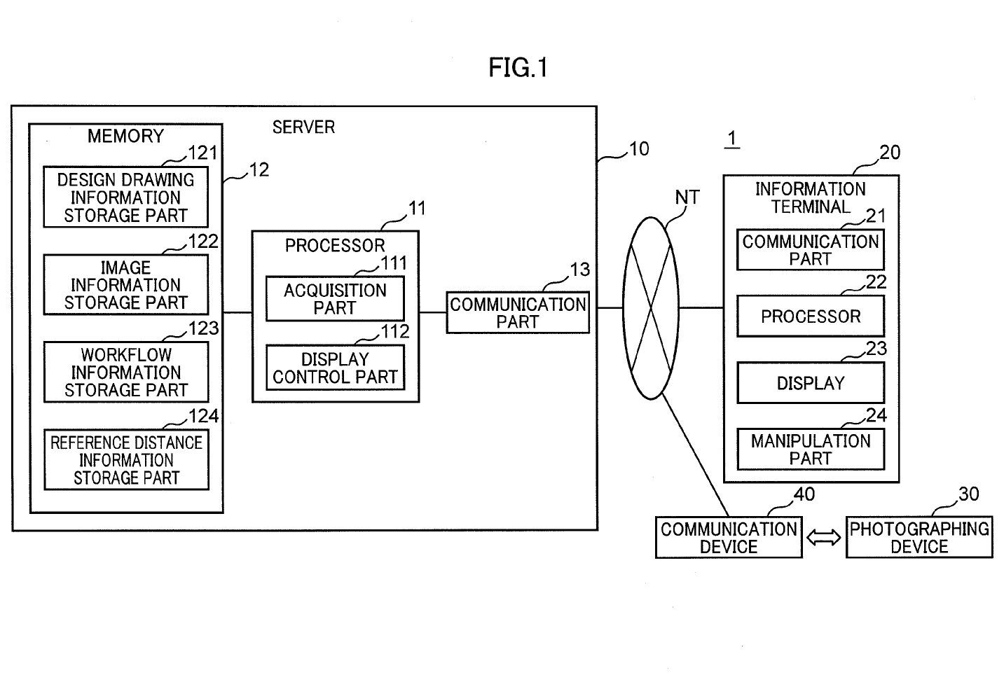

FIG. 1 is diagram showing an overall configuration of an information processing system 1 in an embodiment.

The information processing system 1 is configured to: display a bird’s-eye view for a workspace on a display 23 of an information terminal 20; and display, in the bird’s-eye view, a plurality of photographing spot icons respectively indicating a plurality of photographing spots. The information processing system 1 includes a server 10, the information terminal 20, a photographing device 30, and a communication device 40.

The server 10 is an example of an information processing device and a computer. The server 10, the information terminal 20, and the communication device 40 are communicably connected to one another via a network NT. The network NT includes, for example, the internet. The server 10 includes, for example, a cloud server including one or more computers. However, this is a mere example, and the server 10 may include an edge server, or may be mounted to the information terminal 20. A configuration in which the server 10 is mounted to the information terminal 20 corresponds to an example configuration of the information terminal 20 in the form of an information processing device.

The information terminal 20 is carriable by a user. The user is, for example, a manager of a predetermined space to be photographed by the photographing device 30. The predetermined space is, for example, a construction site. However, this is a mere example, and the predetermined space may be a worksite, a factory, a shop or store, or an office. The information terminal 20 may include a portable computer, e.g., a smartphone or a tablet computer, or may include a stationary computer. The information terminal 20 is configured to display an image on the display 23 under control by the server 10. Although FIG. 1 shows an example of one information terminal 20, a plurality of information terminals may be connected to the server 10 via the network NT. The information terminal 20 includes a communication part 21, a processor 22, the display 23, and a manipulation part 24.

The communication part 21 includes a communication interface that connects the information terminal 20 to the network NT. The communication part 21 is configured to send, to the server 10, instruction signals respectively indicating various instructions which the manipulation part 24 receives from the user. The communication part 21 is configured to receive, from the server 10, display data to display various display screen images.

The processor 22 includes, for example, a central processing unit (CPU), and causes the display 23 to display a display screen image indicated by the display data received by the communication part 21.

The display 23 includes, for example, various display devices, e.g., liquid crystal displays or organic Electro-Luminescence (EL) displays, to display various display screen images under control by the processor 22.

The manipulation part 24 includes, for example, a keyboard, a touch screen, and a mouse, and is configured to receive various instructions input by the user.

The communication device 40 includes a mobile information terminal, e.g., a smartphone or a tablet computer, and connects the photographing device 30 to the network NT. The communication device 40 and the photographing device 30 are communicably connected to each other via a near field communication channel, such as the Bluetooth (registered trademark).

The photographing device 30 includes, for example, an omnidirectional camera, and captures an image at a predetermined frame rate. The omnidirectional camera is also referred to as a 360-degree camera, and can acquire an omnidirectional image at 360 degrees. The photographing device 30 is, for example, a portable photographing device carriable by a photographing person. The photographing person is, for example, a worker or a site supervisor on a construction site. The photographing device 30 may execute photographing in a state of being held in a hand of the photographing person or in a state of being attached to a body (e.g., the head) of the photographing person. The photographing device 30 may include a typical camera.

The photographing person moves on the construction site while photographing the construction site with the photographing device 30. The photographing person presses, at a photographing start spot, a photographing button of the photographing device 30 while making a photographing direction of the photographing device 30 agree with the north direction to start photographing, and presses the photographing button again to finish the photographing when reaching a photographing finish spot. When the photographing is finished, the photographing device 30 sends a series of images having been captured to the communication device 40.

Each image includes a photographing date and time. For instance, the photographing date and time is acquired by a timepiece included in the photographing device 30. Here, the photographing device 30 is configured to capture an image at a predetermined frame rate (e.g., ten frames per second), and therefore, a photographing spot is defined by a frame periodic unit. However, this leads to a huge amount of data, and thus, the photographing spot may be defined for a predetermined time period (e.g., one second, five seconds, or ten seconds).

The communication device 40 is configured to receive the images sent from the photographing device 30. The communication device 40 is further configured to display a design drawing for the construction site, and receive designation by the photographing person about a position corresponding to the photographing start spot and a position corresponding to the photographing finish spot in the design drawing.

The photographing start spot and the photographing finish spot are specified in response to input of instruction from the photographing person to designate the position corresponding to each spot in a design drawing screen image of a site displayed on a display of the communication device 40. A two-dimensional coordinate axis is defined in the design drawing screen image. Thus, each of the photographing start spot and the photographing finish spot is defined by a two-dimensional coordinate value. The server 10 uses each of the photographing start spot and the photographing finish spot to specify a position corresponding to each photographing spot and a photographing direction for each image.

The communication device 40 sends, to the server 10 via the network NT, photographing information including the captured images. The photographing information is generated at every execution of one photographing operation. The one photographing operation means a series of actions from start of photographing to finish of the photographing by a worker carrying the photographing device 30 on the construction site. A plurality of images is captured through the one photographing operation. The photographing information includes the captured images and meta information about each of the images. The meta information includes a photographing ID, a photographing date and time, and a design drawing ID. The photographing ID is an identifier to identify a photographing operation. The photographing date and time represents a photographing date and time for each image. The design drawing ID is an identifier to identify a design drawing for a predetermined space corresponding to an image.

The server 10 includes a processor 11, a memory 12, and a communication part 13. The processor 11 includes, for example, a central processing unit (CPU). The processor 11 includes an acquisition part 111 and a display control part 112. Each of the acquisition part 111 and the display control part 112 may come into effect, for example, when the processor 11 executes an information processing program, or may be established in the form of a dedicated hardware circuit, such as an application specific integrated circuit (ASIC). The information processing program may be recorded in a non-transitory computer-readable recording medium.

The communication part 13 includes a communication interface that connects the server 10 to the network NT. The communication part 13 is configured to receive the photographing information sent from the communication device 40. The communication part 13 is configured to receive, from the information terminal 20, instruction signals respectively indicating various instructions received from the user. The communication part 13 is configured to send, to the information terminal 20, display data to display various display screen images.

The memory 12 includes a non-volatile and rewritable storage device, such as a hard disk drive or a solid state drive. The memory 12 includes a design drawing information storage part 121, an image information storage part 122, a workflow information storage part 123, and a reference distance information storage part 124.

The design drawing information storage part 121 stores design drawing information. The design drawing information includes image information indicating a design drawing for a predetermined space. The design drawing information is associated with a design drawing ID to identify the design drawing. The design drawing is an example of a bird’s-eye view.

The processor 11 is configured to specify, by employing the Visual Simultaneous Localization and Mapping (SLAM) technique, a position corresponding to a photographing spot for each of the images from a photographing start spot, a photographing finish spot, and the images each included in the photographing information received by the communication part 13. Such a position corresponding to the photographing spot is expressed with a two-dimensional coordinate value in the design drawing. The processor 11 further specifies a photographing direction for each of the images by employing the Visual SLAM technique. The photographing direction for each image is expressed with, for example, a three-dimensional polar coordinate vector.

The processor 11 is configured to generate image information on the basis of the photographing information received by the communication part 13, and cause the image information storage part 122 to store the generated image information.

The image information storage part 122 stores image information. The image information associates a plurality of images respectively captured at a plurality of photographing spots and meta information about each of the images with each other. The image information is generated at every receipt of the photographing information. The meta information includes a photographing ID, a photographing date and time, a photographing direction, a photographing spot, and a design drawing ID. The photographing direction represents a photographing direction in which the photographing device 30 has captured each image. The photographing spot represents positional information (a two-dimensional coordinate value) indicating the photographing spot for each image.

The workflow information storage part 123 stores workflow information about a workflow for a construction work. The workflow information is associated with a design drawing ID. For example, the workflow for the construction work includes a framing work stage, an exterior work stage, and an interior work stage. A framing work is performed, and thereafter, an exterior work is performed. Then, the exterior work is performed, and thereafter, an interior work is performed. The framing work stage indicates a work stage of installing pillars, beams, and floors of a building. The exterior work stage indicates a work stage of installing exterior walls of the building. The exterior work stage includes installing exterior members like glass materials, exterior wall panels, external fittings, or other exterior members. The internal work stage indicates a work stage of installing a ceiling, walls, and floors in the building. The internal work stage further includes a phase of dividing the workspace into a plurality of divisions, a phase of installing the ceiling, a phase of making a base for each wall, and a phase of attaching a board to the wall.

Each work stage is predetermined, and a period for each work stage is also predetermined. The workflow information includes a start date and time and a finish date and time for each work stage. A current work stage can be specified with reference to the workflow information. It is noted here that the start date and time and the finish date and time for each work stage may be modified in accordance with a progress status of the workflow.

The reference distance information storage part 124 stores, in advance, reference distance information associating each of the work stages and a reference distance for an interval between two photographing spots being continuous in time-series among a plurality of photographing spots with each other. The reference distance is shorter as the workflow proceeds. For instance, a reference distance of five meters is associated with the framing work stage, a reference distance of three meters is associated with the exterior work stage, and a reference distance of one meter is associated with the interior work stage. The reference distance may be an actual distance in the workspace, or may be a distance in a two-dimensional space in a design drawing. At the framing work stage, only pillars and beams are made in the workspace, and the worker can look out over the workspace broadly. Thus, the reference distance is set to be longer. In contrast, at the interior work stage, walls are made in the workspace, and the worker needs to confirm each of spatial divisions individually. Thus, the reference distance is set to be shorter.

For instance, the reference distance information storage part 124 may store a first reference distance associated with the framing work stage, a second reference distance associated with the exterior work stage, and a third reference distance associated with the interior work stage. The interior work stage may further include work phases in more detail. Specifically, the reference distance information storage part 124 may store a third reference distance associated with the phase of dividing the workspace into a plurality of divisions, a fourth reference distance associated with the phase of installing a ceiling and the phase of making a base of each wall, and a fifth reference distance associated with the phase of attaching a board to the wall.

The communication part 13 receives an instruction to display the design drawing from the information terminal 20. The manipulation part 24 of the information terminal 20 receives selection of the design drawing by the user, and the communication part 21 sends, to the server 10, an instruction to display the design drawing selected by the user. The instruction to display the design drawing contains a design drawing ID.

The communication part 13 is configured to receive an instruction to designate a photographing date and time from the information terminal 20. The manipulation part 24 of the information terminal 20 receives selection of the photographing date and time by the user, and the communication part 21 sends, to the server 10, an instruction to designate the photographing date and time selected by the user. The instruction to designate the photographing date and time contains a photographing ID.

The acquisition part 111 acquires, from the design drawing information storage part 121, a design drawing corresponding to the design drawing ID contained in the instruction to display the design drawing received by the communication part 13. Moreover, the acquisition part 111 acquires, from the image information storage part 122, a plurality of photographing spots each corresponding to the photographing ID contained in the instruction to designate the photographing date and time received by the communication part 13.

The display control part 112 is configured to cause the display 23 of the information terminal 20 to display a design drawing for a workspace. The display control part 112 causes the display 23 of the information terminal 20 to display the design drawing acquired by the acquisition part 111. The display control part 112 is configured to send display data for the design drawing to the information terminal 20 via the communication part 13. The communication part 21 of the information terminal 20 receives the display data sent from the server 10. The display 23 displays the design drawing received by the communication part 21.

The display control part 112 is configured to display, in the design drawing, a plurality of photographing spot icons respectively indicating a plurality of photographing spots. The photographing spots include a first photographing spot and a second photographing spot related to photographing executed at a later time than photographing at the first photographing spot. The display control part 112 is configured to change an interval between a first photographing spot icon indicating the first photographing spot and a second photographing spot icon indicating the second photographing spot in accordance with a workflow in a workspace. The display control part 112 is configured to make the interval between the first photographing spot icon and the second photographing spot icon shorter as the workflow proceeds.

The display control part 112 is configured to decide, on the basis of the workflow, a reference distance for an interval between two photographing spots being continuous in time-series among the photographing spots. The display control part 112 is configured to specify a current work stage with reference to the workflow information stored in the workflow information storage part 123. The display control part 112 decides, as the reference distance for the interval between the two photographing spots, a reference distance associated with the specified current work stage with reference to the reference distance information stored in the reference distance information storage part 124. The reference distance is shorter as the workflow proceeds. As the workflow proceeds, the number of structures including a wall in the workspace increases, and an interval between the structures becomes shorter. Hence, the reference distance is shorter as the interval between the structures in the workspace is shorter.

The display control part 112 is configured to select the first photographing spot from among the photographing spots, and select, as the second photographing spot, a photographing spot located at the reference distance or farther away from the selected first photographing spot from among the photographing spots. The display control part 112 causes the display 23 to display the first photographing spot icon indicating the selected first photographing spot and the second photographing spot icon indicating the selected second photographing spot.

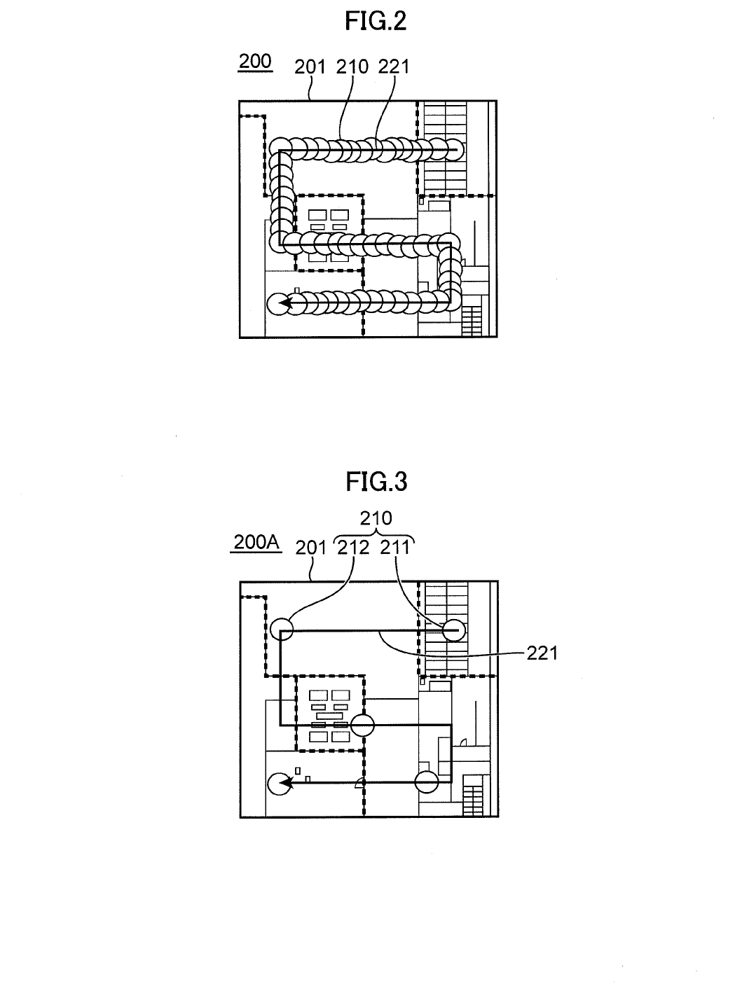

FIG. 2 illustrates an example design drawing screen image 200 in which a plurality of photographing spot icons 210 at intervals to be changed is superimposed. The design drawing screen image 200 shows a design drawing 201 for a workspace. In the design drawing screen image 200, the photographing spot icons 210 are superimposed and displayed.

Each photographing spot icon 210 indicates a photographing spot. The photographing spot icon 210 is associated with an image captured at a corresponding photographing spot. In this example, the photographing spot icon 210 includes an image having a circular shape. The photographing spot icons 210 displayed here respectively correspond to a plurality of photographing spots belonging to one certain photographing operation. A route from the photographing spot icon 210 at one end to the photographing spot icon 210 at another end shows a trace followed by the photographing person in the photographing operation. An arrow 221 indicates the trace followed by the photographing person.

The photographing device 30 captures an image at a predetermined frame rate. In this configuration, the number of photographing spots is expressed with “frame rate (fps) * photographing time (sec.)”. FIG. 2 shows no change in the interval between the photographing spot icons 210. Accordingly, the photographing spot icons 210 are displayed in an overlapping manner along the trace followed by the photographing person.

FIG. 2 shows a position of each wall to be made with a dashed line. At the framing work stage being the initial stage of the workflow, structures including a wall are not yet made in the workspace. That is to say, there are fewer structures which obstruct a visual field of a worker, and hence, it is not required to set a plurality of photographing spots densely. In contrast, at the interior work stage being the later stage of the workflow, such structures including the wall are gradually completed in the workspace and the number of structures which obstruct the visual field of the worker increases, and hence, it is required to set a plurality of photographing spots densely. In this respect, an interval between a plurality of photographing spot icons is changed in accordance with a workflow in the embodiment.

FIG. 3 illustrates an example design drawing screen image 200A, in which a first photographing spot icon 211 and a second photographing spot icon 212 at an interval having been changed are superimposed, for a first work stage. The first wok stage is, for example, the framing work stage. The design drawing screen image 200A shows a design drawing 201 for a workspace. In the design drawing screen image 200A, a plurality of photographing spot icons 210 including the first photographing spot icon 211 and the second photographing spot icon 212 is superimposed and displayed. FIG. 3 shows each wall to be made with a dashed line.

Each photographing spot icon 210 includes an image having a circular shape. The shape of the photographing spot icon 210 is a mere example, and may be another shape. The photographing spot icon 210 is associated with an image captured at a corresponding photographing spot. The manipulation part 24 may receive selection of one photographing spot icon 210 by the user from among the photographing spot icons 210. When the one photographing spot icon 210 is selected from among the photographing spot icons 210, the display control part 112 reads out, from the image information storage part 122, an image corresponding to the selected one photographing spot icon 210, and causes the display 23 to display the read out image.

The display control part 112 is configured to specify a current work stage as the first work stage with reference to the workflow information stored in the workflow information storage part 123. The display control part 112 then decides, as a reference distance for an interval between two photographing spots, a first reference distance associated with the specified first work stage with reference to the reference distance information stored in the reference distance information storage part 124. The reference distance indicates a distance of a movement route or trace of the photographing person.

The display control part 112 is configured to select a leading photographing spot, i.e., a photographing start spot, as the first photographing spot from among the photographing spots. The display control part 112 is configured to select, as the second photographing spot, a photographing spot located at the first reference distance away from the selected first photographing spot from among the photographing spots. The display control part 112 causes the display 23 to display the first photographing spot icon 211 indicating the selected first photographing spot and the second photographing spot icon 212 indicating the selected second photographing spot. Thereafter, the display control part 112 selects a third photographing spot to an N-th photographing spot located at the first reference distance away one after another until no selectable photographing spot located at the first reference distance away remains, and displays a third photographing spot icon to an N-th photographing spot icon respectively indicating the selected third photographing spot to the selected N-th photographing spot.

The display control part 112 may select, as the second photographing spot, a photographing spot located at the first reference distance or farther away from the selected first photographing spot in absence of a photographing spot located at the first reference distance away from the selected first photographing spot. Besides, a photographing spot icon indicating the photographing finish spot may be displayed even in a case where the photographing spot is not at the first reference distance or farther away from one preceding photographing spot having been selected. Alternatively, the photographing spot icon indicating a photographing finish spot may not be displayed in the case where the photographing spot is not at the first reference distance or farther away from one preceding photographing spot having been selected.

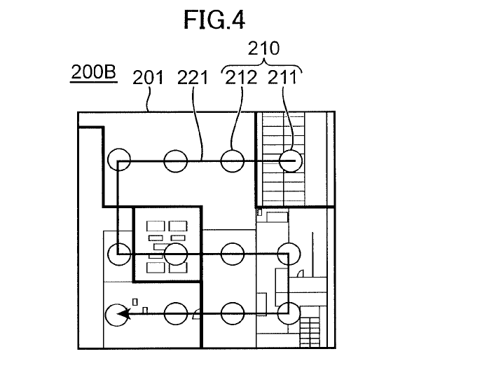

FIG. 4 illustrates an example design drawing screen image 200B, in which a first photographing spot icon 211 and a second photographing spot icon 212 at an interval having been changed are superimposed, for a second work stage coming after the first work stage. The second work stage is, for example, the interior work stage. The design drawing screen image 200B shows the design drawing 201 for the workspace. In the design drawing screen image 200B, a plurality of photographing spot icons 210 including the first photographing spot icon 211 and the second photographing spot icon 212 is superimposed and displayed. FIG. 4 shows each wall having been made with a solid line.

The display control part 112 is configured to specify a current work stage as the second work stage with reference to the workflow information stored in the workflow information storage part 123. The display control part 112 decides, as a reference distance for an interval between two photographing spots, a second reference distance associated with the specified second work stage with reference to the reference distance information stored in the reference distance information storage part 124. The second reference distance is shorter than the first reference distance.

The display control part 112 is configured to select a leading photographing spot, i.e., a photographing start spot, as the first photographing spot from among the photographing spots. The display control part 112 is configured to select, as the second photographing spot, a photographing spot located at the second reference distance away from the selected first photographing spot from among the photographing spots. The display control part 112 causes the display 23 to display the first photographing spot icon 211 indicating the selected first photographing spot and the second photographing spot icon 212 indicating the selected second photographing spot. Thereafter, the display control part 112 selects a third photographing spot to an N-th photographing spot located at the second reference distance away one after another until no selectable photographing spot located at the second reference distance away remains, and displays a third photographing spot icon to an N-th photographing spot icon respectively indicating the selected third photographing spot to the selected N-th photographing spot.

It is noted here that the display control part 112 may select, as the second photographing spot, a photographing spot located at the second reference distance or farther away from the selected first photographing spot in absence of a photographing spot located at the second reference distance away from the selected first photographing spot. Besides, a photographing spot icon indicating a photographing finish spot may be displayed even in a case where the photographing spot is not at the second reference distance or farther away from one preceding photographing spot having been selected. Alternatively, the photographing spot icon indicating a photographing finish spot may not be displayed in the case where the photographing spot is not at the second reference distance or farther away from one preceding photographing spot having been selected.

When FIG. 3 and FIG. 4 are compared with each other, an interval between the photographing spot icons 210 displayed in the design drawing screen image 200B illustrated in FIG. 4 is shorter than an interval between the photographing spot icons 210 displayed in the design drawing screen image 200A illustrated in FIG. 3.

Moreover, when FIG. 2, FIG. 3, and FIG. 4 are compared with one another, the number of photographing spot icons 210 displayed in each of the design drawing screen images 200A and 200B respectively illustrated in FIG. 3 and FIG. 4 is smaller than the number of photographing spot icons 210 displayed in the design drawing screen image 200 illustrated in FIG. 2. Consequently, the embodiment achieves a reduction in the processing burden to display the photographing spot icons 210.

The image information storage part 122 may maintain only images corresponding to photographing spots having been selected, and may delete images corresponding to photographing spots having not been selected. This consequently achieves a reduction in an image data amount stored in the memory 12.

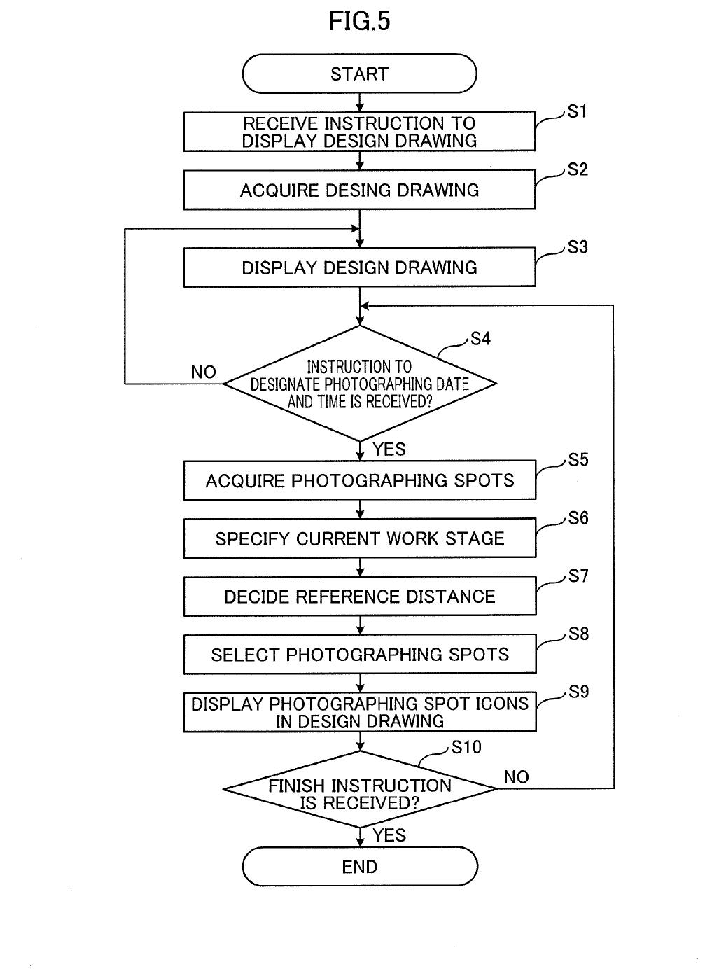

FIG. 5 is a flowchart showing an example of a process by the server 10 in the embodiment.

First, in step S1, the communication part 13 receives, from the information terminal 20, an instruction to display a design drawing. In this case, the display 23 of the information terminal 20 displays a menu screen image for design drawing selection, and the manipulation part 24 receives an instruction from the user to select one design drawing from the menu screen image. The instruction input in this manner is sent to the server 10 via the network NT and received by the communication part 13. The instruction to display the design drawing contains a design drawing ID.

Subsequently, in step S2, the acquisition part 111 acquires, from design drawing information stored in the design drawing information storage part 121, a design drawing corresponding to the design drawing ID contained in the instruction to display the design drawing received by the communication part 13.

Then, in step S3, the display control part 112 sends display data for the design drawing to the information terminal 20 via the communication part 13, and then causes the display 23 of the information terminal 20 to display the design drawing. A display screen image displayed as a default shows the design drawing selected in step S1 and a selection receipt field to select a photographing date and time. The selection receipt field shows photographing dates and times being available for displaying and thus displayed in a selectable manner, and the manipulation part 24 receives an instruction from the user to select a desired photographing date and time in the selection receipt field. Each photographing date and time shown in the selection receipt field indicates a representative value of a photographing date and time included in the image information stored in the memory 12. Examples of the representative value include a photographing start date and time. Selection of the photographing date and time leads to selection of one photographing operation corresponding to the photographing date and time. The instruction to designate the photographing date and time is sent to the server 10 via the network NT and received by the communication part 13. The instruction to designate the photographing date and time contains a photographing ID.

Next, in step S4, the acquisition part 111 determines whether the communication part 13 receives an instruction to designate a photographing date and time. When it is determined that the communication part 13 receives no instruction to designate a photographing date and time (NO in step S4), the process returns to step S3.

In contrast, when it is determined that the communication part 13 receives an instruction to designate a photographing date and time (YES in step S4), the acquisition part 111 acquires, from the image information stored in the image information storage part 122, a plurality of photographing spots each corresponding to the photographing ID contained in the instruction to designate the photographing date and time received by the communication part 13, in step S5.

Subsequently, in step S6, the display control part 112 specifies a current work stage with reference to the workflow information stored in the workflow information storage part 123. The display control part 112 specifies a work stage related to a current date and time.

Then, in step S7, the display control part 112 decides, on the basis of the specified current work stage, a reference distance for an interval between two photographing spots with reference to the reference distance information stored in the reference distance information storage part 124. The display control part 112 reads out a reference distance associated with the specified current work stage from the reference distance information storage part 124.

Next, in step S8, the display control part 112 selects a plurality of photographing spots at an interval of the reference distance from among the acquired photographing spots. At this time, the display control part 112 selects a first photographing spot from among the photographing spots, and selects, as a second photographing spot, a photographing spot located at a distance being the reference distance away from the selected first photographing spot from among the photographing spots.

Subsequently, in step S9, the display control part 112 sends, to the information terminal 20 via the communication part 13, a display instruction to display, in the design drawing, a plurality of photographing spot icons respectively indicating the selected photographing spots, and then displays, in the design drawing being displayed on the display 23 of the information terminal 20, the photographing spot icons respectively indicating the selected photographing spots. At this time, the display control part 112 displays, in the design drawing, a first photographing spot icon indicating the selected first photographing spot and a second photographing spot icon indicating the selected second photographing spot.

Then, in step S10, the acquisition part 111 determines whether the communication part 13 receives a finish instruction. The finish instruction is an instruction to close the design drawing displayed in step S3. The instruction is input in response to a manipulation to press a finish button (not shown) displayed on the display 23. When it is determined that the communication part 13 receives a finish instruction (YES in step S10), the process is finished. In contrast, when it is determined that the communication part 13 does not receive a finish instruction (NO in step S10), the process returns to step S4. In this case, the displaying of the design drawing is maintained. The finish instruction is sent to the server 10 via the network NT and received by the communication part 13. The acquisition part 111 acquires the finish instruction via the communication part 13.

This configuration includes changing the interval between the first photographing spot icon 211 indicating the first photographing spot and the second photographing spot icon 212 indicating the second photographing spot in accordance with a workflow, and thus enables change in an interval between a plurality of photographing spot icons respectively indicating a plurality of photographing spots in accordance with the workflow. The configuration that includes changing the interval between the photographing spot icons in accordance with the workflow avoids an increase in the number of processing steps by a computer, and hence prevents an increase in a burden on computer resources.

This disclosure can adopt modifications described below.
(1) Although the workflow information storage part 123 stores the workflow information in advance and the display control part 112 is configured to specify a current work stage with reference to the workflow information in the embodiment, the present disclosure is not particularly limited thereto. In a first modification of the embodiment, a display control part 112 may specify a work stage on the basis of an interval between structures in a workspace. In this configuration, the display control part 112 may recognize structures shown in images respectively captured at a plurality of photographing spots. Examples of the structures include a wall. The display control part 112 may detect an interval between the recognized structures, and specify a current work stage from the detected interval between the structures.
(2) Although the display control part 112 decides, on the basis of a workflow, a reference distance for an interval between two photographing spots being continuous in time-series from among a plurality of photographing spots in the embodiment, the present disclosure is not particularly limited thereto. In a second modification of the embodiment, a display control part 112 may divide a design drawing into a plurality of regions. The display control part 112 may further decide a reference distance on the basis of an area of each of the regions, a length of a perimeter of each of the regions, a horizontal dimension of each of the regions, or a vertical dimension of each of the regions. At this time, the display control part 112 may divide the design drawing into the regions in such a manner as to be each surrounded by a wall.

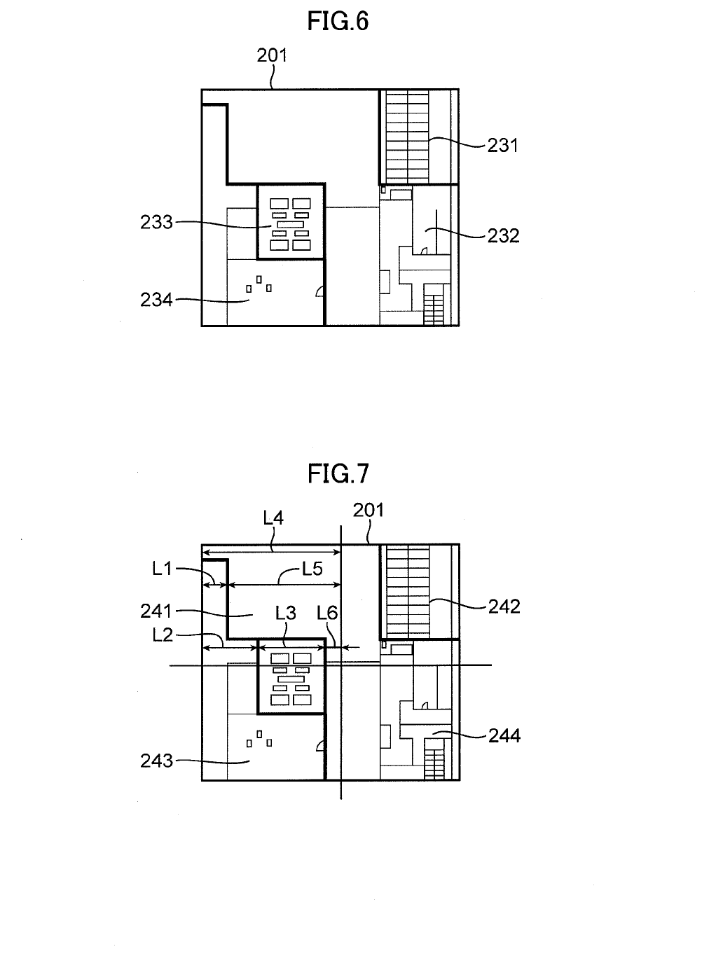

FIG. 6 is a schematic diagram to explain decision of a reference distance by the display control part 112 in the second modification of the embodiment.

FIG. 6 illustrates a design drawing 201 including a plurality of regions 231, 232, 233, and 234 respectively surrounded by walls made in a workspace. Here, a position of each wall may be detected through recognition of a structure shown in images respectively captured at a plurality of photographing spots. The position of the wall may be detected from the design drawing.

The reference distance information storage part 124 may store, in advance, reference distance information associating each of ranges of a plurality of areas and a reference distance for an interval between two photographing spots being continuous in time-series with each other among a plurality of photographing spots. The display control part 112 may calculate respective areas of the regions 231, 232, 233, and 234, and calculate an average of the respective areas of the regions 231, 232, 233, and 234. The display control part 112 may determine which of the ranges of the areas meets the calculated average of the areas, and decide, as the reference distance for the interval between the two photographing spots, a reference distance associated with the determined range of the area.

The reference distance information storage part 124 may store, in advance, reference distance information associating each of ranges of lengths of a plurality of perimeters and the reference distance for the interval between the two photographing spots being continuous in time-series among the photographing spots with each other. The display control part 112 may calculate lengths of respective perimeters of the regions 231, 232, 233, and 234, and calculate an average of the lengths of the respective perimeters of the regions 231, 232, 233, and 234. The display control part 112 may determine which of the ranges of the lengths of the perimeters meets the calculated average of the lengths of the perimeters, and decide, as the reference distance for the interval between the two photographing spots, a reference distance associated with the determined range of the length of the perimeter.

The reference distance information storage part 124 may store, in advance, reference distance information associating each of ranges of a plurality of horizontal dimensions and the reference distance for the interval between the two photographing spots being continuous in time-series among the photographing spots with each other. The display control part 112 may calculate respective horizontal dimensions of the regions 231, 232, 233, and 234, and calculate an average of the respective horizontal dimensions of the regions 231, 232, 233, and 234. A shape of each region is not necessarily a quadrangular shape. In FIG. 6, each of the regions 231, 233 has a quadrangular shape, and each of the regions 232 and 234 has a polygonal shape. In a case where a region has a polygonal shape, the display control part 112 may define a longest horizontal dimension or a shortest horizontal dimension among a plurality of horizontal dimensions of the region different from one another as the horizontal dimension of the region. Alternatively, in the case where the region has the polygonal shape, the display control part 112 may define an average of the horizontal dimensions of the region different from one another as the horizontal dimension of the region. The display control part 112 may determine which of the ranges of the horizontal dimensions meets the calculated average of the horizontal dimensions, and decide, as the reference distance for the interval between the two photographing spots, a reference distance associated with the determined range of the horizontal dimension.

The reference distance information storage part 124 may store, in advance, reference distance information associating each of ranges of a plurality of vertical dimensions and the reference distance for the interval between the two photographing spots being continuous in time-series among the photographing spots with each other. The display control part 112 may calculate respective vertical dimensions of the regions 231, 232, 233, and 234, and calculate an average of the respective vertical dimensions of the regions 231, 232, 233, and 234. In a case where a region has a polygonal shape, the display control part 112 may define a longest vertical dimension or a shortest vertical dimension among a plurality of vertical dimensions of the region different from one another as the vertical dimension of the region. Alternatively, in the case where the region has the polygonal shape, the display control part 112 may define an average of the vertical dimensions of the region different from one another as the vertical dimension of the region. The display control part 112 may determine which of the ranges of the vertical dimensions meets the calculated average of the vertical dimensions, and decide, as the reference distance for the interval between the two photographing spots, a reference distance associated with the determined range of the vertical dimension.

(3) Although the display control part 112 divides the design drawing into a plurality of regions in such a manner as to be each surrounded by a wall in the second modification of the embodiment, the present disclosure is not particularly limited thereto. In a third modification of the embodiment, a display control part 112 may divide a design drawing into a plurality of regions in a grid shape. The display control part 112 may decide a reference distance on the basis of a horizontal dimension or a vertical dimension of each of the regions that is defined between associated walls included in the region.

FIG. 7 is a schematic diagram to explain decision of a reference distance by the display control part 112 in the third modification of the embodiment.

FIG. 7 illustrates a design drawing 201 divided into four regions 241, 242, 243, and 244 in a grid shape. Here, a position of each wall may be detected through recognition of a structure shown in images respectively captured at a plurality of photographing spots. The position of the wall may be detected from the design drawing.

The reference distance information storage part 124 may store, in advance, reference distance information associating each of ranges of a plurality of horizontal dimensions and a reference distance for an interval between two photographing spots being continuous in time-series among a plurality of photographing spots with each other. The display control part 112 may calculate a horizontal dimension defined between a wall and another wall, and calculate a horizontal dimension defined between a wall and a region boundary for each of the regions 241, 242, 243, and 244. Besides, in a case where a region includes walls, a plurality of horizontal dimensions L1, L2, and L3 each defined between associated two walls is calculated, and a plurality of horizontal dimensions L4, L5 , and L6 each defined between an associated wall and an associated region boundary is calculated. The display control part 112 may define a longest horizontal dimension or a shortest horizontal dimension among a plurality of horizontal dimensions of a region different from one another as the horizontal dimension of the region. Alternatively, the display control part 112 may define an average of the horizontal dimensions of the region different from one another as the horizontal dimension of the region. The display control part 112 may calculate an average of the respective horizontal dimensions of the regions 241, 242, 243, and 244. The display control part 112 may determine which of the ranges of the horizontal dimensions meets the calculated average of the horizontal dimensions, and decide, as the reference distance for the interval between the two photographing spots, a reference distance associated with the determined range of the horizontal dimension.

The reference distance information storage part 124 may store, in advance, reference distance information associating each of ranges of a plurality of vertical dimensions and the reference distance for the interval between the two photographing spots being continuous in time-series among the photographing spots with each other. The display control part 112 may calculate a vertical dimension defined between a wall and another wall, and calculate a vertical dimension defined between a wall and a region boundary for each of the regions 241, 242, 243, and 244. Besides, in a case where a region includes walls, a plurality of vertical dimensions each defined between associated two walls is calculated, and a plurality of vertical dimensions each defined between an associated wall and an associated region boundary is calculated. The display control part 112 may define a longest vertical dimension or a shortest vertical dimension among the vertical dimensions of the region different from one another as the vertical dimension of the region. Alternatively, the display control part 112 may define an average of the vertical dimensions of the region different from one another as the vertical dimension of the region. The display control part 112 may calculate an average of the respective vertical dimensions of the regions 241, 242, 243, and 244. The display control part 112 may determine which of the ranges of the vertical dimensions meets the calculated average of the vertical dimensions, and decide, as the reference distance for the interval between the two photographing spots, a reference distance associated with the determined range of the vertical dimension.

(4) In a fourth modification of the embodiment, a display control part 112 may divide a design drawing into a plurality of regions, and decide a reference distance for each of the regions. In this configuration, the display control part 112 is configured to change an interval between a plurality of photographing spot icons for each of the regions.

The regions may be the regions 231, 232, 233, and 234 each surrounded by a wall as illustrated in FIG. 6.

The reference distance information storage part 124 may store, in advance, reference distance information associating each of ranges of a plurality of areas and a reference distance for an interval between two photographing spots being continuous in time-series with each other among a plurality of photographing spots. The display control part 112 may calculate an area of each of the regions 231, 232, 233, and 234. The display control part 112 may determine which of the ranges of the areas meets the calculated area of each of the regions 231, 232, 233, and 234, and decide, as the reference distance for each of the regions 231, 232, 233, and 234, a reference distance associated with the determined range of the area.

The reference distance information storage part 124 may store, in advance, reference distance information associating each of ranges of lengths of a plurality of perimeters and the reference distance for the interval between the two photographing spots being continuous in time-series among the photographing spots with each other. The display control part 112 may calculate a length of a perimeter of each of the regions 231, 232, 233, and 234. The display control part 112 may determine which of the ranges of the lengths of the perimeters meets the calculated length of the perimeter of each of the regions 231, 232, 233, and 234, and decide, as the reference distance for each of the regions 231, 232, 233, and 234, a reference distance associated with the determined range of the length of the perimeter.

The reference distance information storage part 124 may store, in advance, reference distance information associating each of ranges of a plurality of horizontal dimensions and the reference distance for the interval between the two photographing spots being continuous in time-series among the photographing spots with each other. The display control part 112 may calculate respective horizontal dimensions of the regions 231, 232, 233, and 234. In a case where a region has a polygonal shape, the display control part 112 may define a longest horizontal dimension or a shortest horizontal dimension among a plurality of horizontal dimensions of the region different from one another as the horizontal dimension of the region. Alternatively, in the case where the region has the polygonal shape, the display control part 112 may define an average of the horizontal dimensions of the region different from one another as the horizontal dimension of the region. The display control part 112 may determine which of the ranges of the horizontal dimensions meets the calculated horizontal dimension of each of the regions 231, 232, 233, and 234, and decide, as the reference distance for each of the regions 231, 232, 233, and 234, a reference distance associated with the determined range of the horizontal dimension.

The reference distance information storage part 124 may store, in advance, reference distance information associating each of ranges of a plurality of vertical dimensions and the reference distance for the interval between the two photographing spots being continuous in time-series among the photographing spots with each other. The display control part 112 may calculate respective vertical dimensions of the regions 231, 232, 233, and 234. In a case where a region has a polygonal shape, the display control part 112 may define a longest vertical dimension or a shortest vertical dimension among a plurality of vertical dimensions of the region different from one another as the vertical dimension of the region. Alternatively, in the case where the region has the polygonal shape, the display control part 112 may define an average of the vertical dimensions of the region different from one another as the vertical dimension of the region. The display control part 112 may determine which of the ranges of the vertical dimensions meets the calculated vertical dimension of each of the regions 231, 232, 233, and 234, and decide, as the reference distance for each of the regions 231, 232, 233, and 234, a reference distance associated with the determined range of the vertical dimension.

The regions may be the regions 241, 242, 243, and 244 resulting from dividing the design drawing in the grid shape as illustrated in FIG. 7.

The reference distance information storage part 124 may store, in advance, reference distance information associating each of ranges of a plurality of horizontal dimensions and the reference distance for the interval between the two photographing spots being continuous in time-series among the photographing spots with each other. The display control part 112 may calculate a horizontal dimension defined between a wall and another wall, and calculate a horizontal dimension defined between a wall and a region boundary for each of the regions 241, 242, 243, and 244. Besides, in a case where a region includes walls, a plurality of horizontal dimensions L1, L2, and L3 each defined between associated two walls is calculated, and a plurality of horizontal dimensions L4, L5, and L6 each defined between an associated wall and an associated region boundary is calculated. The display control part 112 may define a longest horizontal dimension or a shortest horizontal dimension among a plurality of horizontal dimensions of a region different from one another as the horizontal dimension of the region. Alternatively, the display control part 112 may define an average of the horizontal dimensions of the region different from one another as the horizontal dimension of the region. The display control part 112 may determine which of the ranges of the horizontal dimensions meets the calculated horizontal dimension of each of the regions 241, 242, 243, and 244, and decide, as the reference distance for each of the regions 241, 242, 243, and 244, a reference distance associated with the determined range of the horizontal dimension.

The reference distance information storage part 124 may store, in advance, reference distance information associating each of ranges of a plurality of vertical dimensions and the reference distance for the interval between the two photographing spots being continuous in time-series among the photographing spots with each other. The display control part 112 may calculate a vertical dimension defined between a wall and another wall, and calculate a vertical dimension defined between a wall and a region boundary for each of the regions 241, 242, 243, and 244. Besides, in a case where a region includes walls, a plurality of vertical dimensions each defined between associated two walls is calculated, and a plurality of horizontal dimensions each defined between an associated wall and an associated region boundary is calculated. The display control part 112 may define a longest vertical dimension or a shortest vertical dimension among the vertical dimensions of the region different from one another as the vertical dimension of the region. Alternatively, the display control part 112 may define an average of the vertical dimensions of the region different from one another as the vertical dimension of the region. The display control part 112 may determine which of the ranges of the vertical dimensions meets the calculated vertical dimension of each of the regions 241, 242, 243, and 244, and decide, as the reference distance for each of the regions 241, 242, 243, and 244, a reference distance associated with the determined range of the vertical dimension.

(5) In the embodiment, changing an interval between a first photographing spot icon and a second photographing spot icon may result in bringing the second photographing spot icon closer to a structure. In this case, an image captured at a second photographing spot indicated by the second photographing spot icon means an image captured at an extremely short distance from the structure. This makes it difficult for a worker to confirm a state of the structure. In this regard, in a fifth modification of the embodiment, a display control part 112 may decide, when a distance between the second photographing spot and a certain structure in a workspace has a value lower than a threshold, a photographing spot located at a distance of the threshold or higher away from the structure among the photographing spots as the second photographing spot.

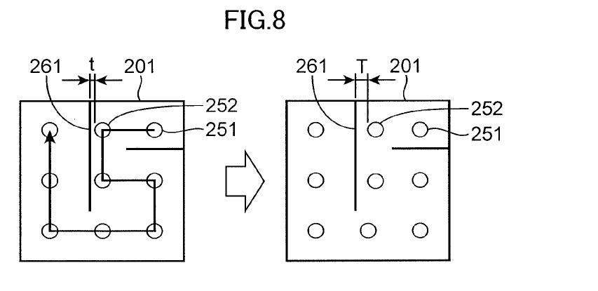

FIG. 8 is a schematic diagram to explain change in a photographing spot icon by the display control part 112 in the fifth modification of the embodiment.

As illustrated in FIG. 8, a first photographic spot 251 is selected from among a plurality of photographing spots, and a photographing spot at a reference distance or farther away from the selected first photographing spot 251 is selected as a second photographing spot 252 from among the photographing spots, and thereafter, the display control part 112 determines whether a distance t between the second photographing spot 252 and a structure 261 located closest to the second photographing spot 252 in a workspace has a value lower than a threshold T. Examples of the structure 261 include a wall. Here, when it is determined that the distance t between the second photographing spot 252 and the structure 261 located closest to the second photographing spot 252 has a value lower than the threshold T, the display control part 112 decides, as the second photographing spot 252, a photographing spot located at a distance of the threshold or higher away from the structure 261 among the photographing spots.

A technology according to the present disclosure enables change in an interval between a plurality of photographing spot icons respectively indicating a plurality of photographing spots in accordance with a workflow, and thus is useful as a technology to display an image.

1. An information processing method to be executed by a computer, comprising: displaying a bird’s-eye view for a workspace on a display of an information terminal; and displaying, in the bird’s-eye view, a plurality of photographing spot icons respectively indicating a plurality of photographing spots, wherein the photographing spots include a first photographing spot and a second photographing spot related to photographing executed at a later time than photographing at the first photographing spot, and the displaying of the photographing spot icons includes changing an interval between a first photographing spot icon indicating the first photographing spot and a second photographing spot icon indicating the second photographing spot in accordance with a workflow in the workspace.

2. The information processing method according to claim 1, wherein
the displaying of the photographing spot icons includes making the interval between the first photographing spot icon and the second photographing spot icon shorter as the workflow proceeds.

3. The information processing method according to claim 1, further comprising specifying a work stage in the workflow on the basis of an interval between structures in the workspace.

4. The information processing method according to claim 1, further comprising deciding, on the basis of the workflow, a reference distance for an interval between two photographing spots being continuous in time-series among the photographing spots, wherein the displaying of the photographing spot icons includes: selecting the first photographing spot from among the photographing spots, and selecting, as the second photographing spot, a photographing spot located at the reference distance or farther away from the selected first photographing spot; and displaying, in the bird’s-eye view, the first photographing spot icon indicating the selected first photographing spot and the second photographing spot icon indicating the selected second photographing spot.

5. The information processing method according to claim 4, wherein the reference distance is shorter as the interval between structures in the workspace is shorter.

6. The information processing method according to claim 4, further comprising
dividing the bird’s-eye view into a plurality of regions, wherein
the deciding of the reference distance includes deciding the reference distance on the basis of an area of each of the regions, a length of a perimeter of each of the regions, a horizontal dimension of each of the regions, or a vertical dimension of each of the regions.

7. The information processing method according to claim 6, wherein the dividing of the bird’s-eye view includes dividing the bird’s-eye view into the regions in such a manner as to be each surrounded by a wall.

8. The information processing method according to claim 6, wherein
the dividing of the bird’s-eye view includes dividing the bird’s-eye view into the regions in a grid shape, and
the deciding of the reference distance includes deciding the reference distance on the basis of the horizontal dimension or the vertical dimension that is defined between associated walls included in the region.

9. The information processing method according to claim 4, wherein the deciding of the reference distance includes: dividing the bird’s-eye view into a plurality of regions; and deciding the reference distance for each of the regions.

10. The information processing method according to claim 1, further comprising deciding, when a distance between the second photographing spot and a certain structure in the workspace has a value lower than a threshold, a photographing spot located at a distance of the threshold or higher away from the structure among the photographing spots as the second photographing spot.

11. An information processing device, comprising: a processor, the processor being configured to: display a bird’s-eye view for a workspace on a display of an information terminal; and display, in the bird’s-eye view, a plurality of photographing spot icons respectively indicating a plurality of photographing spots, wherein the photographing spots include a first photographing spot and a second photographing spot related to photographing executed at a later time than photographing at the first photographing spot, and, in the displaying of the photographing spot icons, an interval between a first photographing spot icon indicating the first photographing spot and a second photographing spot icon indicating the second photographing spot is changed in accordance with a workflow in the workspace.

12. A non-transitory computer readable recording medium storing an information processing program, comprising: causing a computer to: display a bird’s-eye view for a workspace on a display of an information terminal; and display, in the bird’s-eye view, a plurality of photographing spot icons respectively indicating a plurality of photographing spots, wherein the photographing spots include a first photographing spot and a second photographing spot related to photographing executed at a later time than photographing at the first photographing spot, and, in the displaying of the photographing spot icons, an interval between a first photographing spot icon indicating the first photographing spot and a second photographing spot icon indicating the second photographing spot is changed in accordance with a workflow in the workspace.
